(19) United States
(12) Patent Application Publication
(10) Pub. No.: US 2020/0039287 A1
(43) Pub. Date: Feb. 6, 2020

(54) OMNI WHEEL INCLUDING SUSPENSION STRUCTURE

(71) Applicant: Sung Eun YOUN, Cheonan-si (KR)

(72) Inventor: Sung Eun YOUN, Cheonan-si (KR)

(21) Appl. No.: 16/528,507

(22) Filed: Jul. 31, 2019

(30) Foreign Application Priority Data
Jul. 31, 2018 (KR) 10-2018-0089344

(51) Int. Cl. B60B 19/00; B60B 19/12

(52) U.S. Cl. CPC B60B 19/003; B60B 19/125

(57) ABSTRACT

Provided is an omni wheel including a suspension structure, which may sustain an increased load and drive on a rough terrain such as a stairway or a bumpy ground, and which includes a flywheel unit receiving power from outside and rotating around a rotation axis; suspension units formed radially on opposite surfaces of the flywheel unit; and a ground wheel having opposite ends connected to ends of a pair of the suspension units formed on one surface and the other surface of the flywheel unit, respectively.

### CROSS-REFERENCE TO RELATED APPLICATIONS

This application claims priority under 35 U.S.C. § 119 to Korean Patent Application No. 10-2018-0089344, filed on Jul. 31, 2018, in the Korean Intellectual Property Office, the disclosure of which is incorporated herein by reference in its entirety.

### TECHNICAL FIELD

The following disclosure relates to an omni wheel including an individual suspension structure, and more particularly, to an omni wheel including an individual suspension structure used for each wheel and designed to load a heavy load and to be easily move in a terrain such as a stairway or a bumpy ground.

### BACKGROUND

A conventional wheel is only able to move forward/backward; however, an omni wheel is a special wheel which may move forward/backward and also move left/right without changing a direction of the omni wheel itself.

The omni wheel includes one main wheel and a plurality of auxiliary wheels which are assembled to the main wheel and rotate freely around the main wheel. There are various types of omni wheels depending on the number of auxiliary wheels, a direction in which the auxiliary wheels are assembled to the main wheel and a shape of the auxiliary wheel.

The main wheel of the omni wheel rotates around a rotation axis of a motor like the conventional wheel, and the auxiliary wheel is made to slip in a rotation axis direction (perpendicular to the main wheel) by an external force, so that a vehicle or a moving body using the omni wheel may move left/right as well as forward/backward.

Japanese Patent Publication No. 5099772 (entitled “Wheel Chair Drive Unit”; published on Oct. 5, 2012; and hereinafter, Prior art document 1) is known as a technique related to a conventional omni wheel. The technique disclosed in Prior art document 1 may be summarized as follows. In order to automatically drive a conventional wheelchair which is manually operated, a wheelchair drive unit of Prior art document 1 is disposed below the manually-operated wheelchair. In detail, in order to make the manual wheelchair move automatically, the wheelchair drive unit is disposed below the manual wheelchair and has a structure in which four omni wheels support a bogie which is disposed below the manual wheelchair and supports the wheelchair. Due to a structure in which only one suspension structure exists between the bogie and a single omni wheel, an impact on the bogie may be eliminated.

In the omni wheel including a suspension structure as disclosed in Prior art document 1, a single omni wheel includes only one suspension; therefore, an impact transmitted through the omni wheel may be mitigated at a relatively low price. However, the omni wheel may not sustain a heavy load and may not be suitable for driving on a rough terrain such as a stairway or a bumpy ground.

### CITED REFERENCE

### Patent Document

Japanese Patent Publication No. 5099772 (entitled “Wheel Chair Drive Unit” and published on Oct. 5, 2012)

### SUMMARY

An embodiment of the present disclosure is directed to providing an omni wheel including a suspension structure, which may sustain an increased load and drive on a rough terrain such as a stairway or a bumpy ground.

In one general aspect, an omni wheel including a suspension structure may include: a flywheel unit receiving power from outside and rotating around a rotation axis; suspension units formed radially on opposite surfaces of the flywheel unit; and a ground wheel connected to ends of at least two of the suspension units.

In the omni wheel including a suspension structure, opposite ends of the ground wheel may be connected to ends of a pair of the suspension units formed on one surface and the other surface of the flywheel unit, respectively.

In the omni wheel including a suspension structure, the ground wheel may be connected to ends of at least two of the suspension units formed on one surface of the flywheel unit.

In the omni wheel including a suspension structure, the flywheel unit may include a pair of flywheels spaced apart from and assembled to each other.

In the omni wheel including a suspension structure, the flywheel unit may further include covers covering outer surfaces of the flywheels, and the suspension units may be positioned between the flywheel and the cover.

In the omni wheel including a suspension structure, an insertion protrusion may be formed on one surface of the suspension unit, and an inserting space to which the insertion protrusion is inserted may be formed to be recessed in or to penetrate through one surface of the flywheel or the cover.

In the omni wheel including a suspension structure, receiving spaces may be formed radially on the opposite surfaces of the flywheel unit, and each of the suspension units may include: a cylinder body inserted to the receiving space; a piston structure and a shock spring inserted to the cylinder body; and a rod having an end to which the piston structure is connected.

In the omni wheel including a suspension structure, a fluid may fill the cylinder body.

In the omni wheel including a suspension structure, the ground wheel may include a body rotatably assembled to the suspension unit at a distal end or middle ends of the ground wheel and a tire surrounding the body.

In the omni wheel including a suspension structure, protrusions may be formed on a surface of the tire.

In the omni wheel including a suspension structure, the suspension unit may extend in a direction may be a tangential direction of an imaginary circle having the rotation axis and having a radius smaller than a radius of the flywheel unit.

In the omni wheel including a suspension structure, when viewing the rotation axis of the flywheel unit in a horizontal direction or in a vertical direction, the ground wheel may be assembled to the suspension units so that a direction in which the ground wheel extends forms a diagonal line with the rotation axis.

Other features and aspects will be apparent from the following detailed description, the drawings and the claims.

### BRIEF DESCRIPTION OF THE DRAWINGS

FIG. 1 is a perspective view illustrating an assembled state of an omni wheel including a suspension structure according to a first exemplary embodiment.

FIG. 2 is a partially exploded perspective view illustrating the omni wheel including a suspension structure according to the first exemplary embodiment of the present disclosure.

FIG. 3 is a perspective view illustrating an assembled state of flywheels of the omni wheel including a suspension structure according to the first exemplary embodiment of the present disclosure.

FIG. 4 is a perspective view illustrating an assembled state of a suspension unit and a ground wheel of the omni wheel including a suspension structure according to the first exemplary embodiment of the present disclosure.

FIG. 5 is a front view illustrating a partially-assembled state of the omni wheel including a suspension structure according to the first exemplary embodiment of the present disclosure.

FIG. 6 is a side view illustrating an assembled state of the omni wheel including a suspension structure according to the first exemplary embodiment of the present disclosure.

FIG. 7 is a perspective view illustrating an assembled state of an omni wheel including a suspension structure according to a second exemplary embodiment of the present disclosure.

FIG. 8 is an exploded perspective view illustrating the omni wheel including a suspension structure according to the second exemplary embodiment of the present disclosure.

### DETAILED DESCRIPTION OF EMBODIMENTS

Hereinafter, an omni wheel including a suspension structure according to exemplary embodiments of the present disclosure is described in detail with reference to the accompanying drawings.

### First Exemplary Embodiment

An omni wheel including a suspension structure according to various exemplary embodiments of the present disclosure is used as a wheel of a vehicle or a moving body and thus designed to drive on a rough terrain such as a stairway or a bumpy ground.

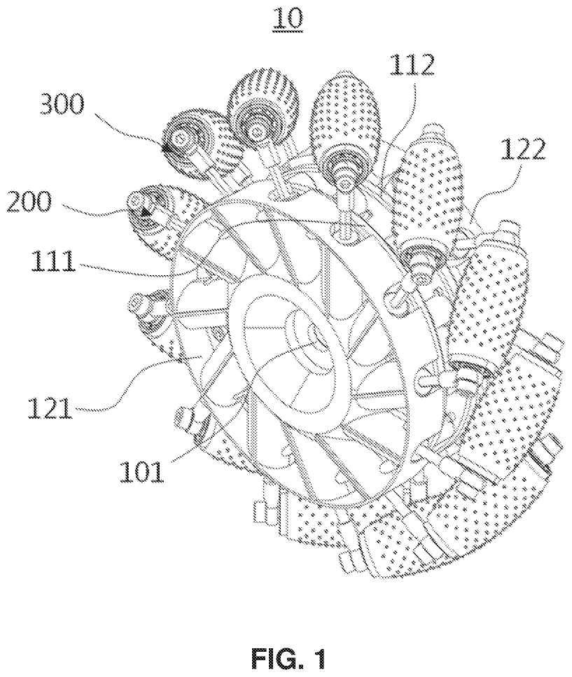

FIG. 1 is a view illustrating an omni wheel 10 including a suspension structure according to a first exemplary embodiment.

As illustrated in FIG. 1, the omni wheel 10 including a suspension structure according to the first exemplary embodiment may include a flywheel unit, a suspension unit 200 and a ground wheel 300.

The flywheel unit may receive power from outside and rotate around a rotation axis 101. As illustrated in FIG. 1, the flywheel unit may include a first flywheel 111 and a second flywheel 112 assembled to each other, and a first cover 121 and a second cover 122 assembled to outer circumferential surfaces of the first flywheel 111 and the second flywheel 112, respectively.

The first and second flywheels 111 and 112, and the first and second covers 121 and 122 are for distinguishing the flywheel unit and the covers from each other. Hereinafter, for convenience of explanation, the first flywheel and the second flywheel may be collectively referred to as a flywheel 111 and the first cover and the second cover may be collectively referred to as a cover 121.

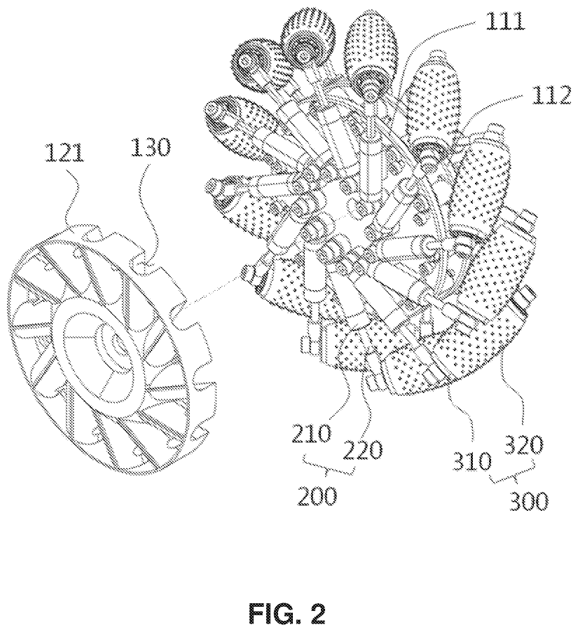

FIG. 2 is a view illustrating the omni wheel 10 including a suspension structure according to the first exemplary embodiment of the present disclosure in a state in which the second cover is omitted from illustration and the first cover 121 is spaced apart from the flywheel unit.

As illustrated in FIG. 2, the suspension units 200 are fixedly assembled to opposite surfaces of the flywheel unit, i.e. respective outer surfaces of the first and second flywheels 111 and 112 (each surface of the flywheels opposite to a direction in which the flywheels are assembled to each other); and a plurality of suspension units 200 are disposed radially around the rotation axis 101 of the flywheel unit.

As illustrated in FIG. 2, an outer end of the suspension unit 200 is assembled to the ground wheel 300 in contact with the ground and thus serves to mitigate an impact transmitted from the ground to the flywheel unit through the ground wheel 300. The suspension unit 200 may include a cylinder body 210 and a rod 220 to serve the above-described role.

As illustrated in FIG. 2, the cylinder body 210 is formed in the suspension unit 200 in a direction of the rotation axis 101. The cylinder body 210 may include a piston structure and a shock spring, and a fluid for mitigating the impact may also fill the cylinder body 210. The fluid filling the cylinder body 210 may be oil generally used in a cylinder structure, but a kind of fluid filling the cylinder body 210 of the present disclosure is not limited to the oil.

A screw is inserted into an end of the cylinder body 210 in the direction of the rotation axis 101, in the direction of the flywheel 111 to fix the cylinder body 210 and the flywheel 111 to each other. The cylinder body 210 may be formed to extend outwardly from an end thereof in a direction of the rotation axis 101.

An end of the rod 220 is connected to the piston structure included in the cylinder body 210 and moves/returns along the cylinder body 210. The other end of the rod 220 (in a direction opposite to the rotation axis 101) may be assembled to the ground wheel 300.

The suspension unit 200 has a structure used for each ground wheel 300 as described above. In general, when the omni wheel drives on the ground, the number of the ground wheels 300 in contact with the ground is small as compared to the number of all the ground wheels 300 used for the omni wheel. However, in the present disclosure, since the suspension unit 200 is used for each ground wheel 300, it is possible to mitigate the impact on the ground wheel 300 in contact with the ground. That is, when the ground wheel 300 assembled to the end of the rod 220 is pushed or impacted by a load, the rod 220 and the piston structure connected to the rod 220 move in the direction of the rotation axis 101 in the cylinder body 210 and return to mitigate the impact.

As illustrated in FIG. 2, a plurality of suspension units 200 each including the cylinder body 210 and the rod 220 may be assembled between the flywheel 111 and the cover 121; and the suspension units 200 may be fixed together when assembling the cover 121 and the flywheel 111 each other.

In more detail, a space for receiving the suspension unit 200 is required between the flywheels 111 and 112 and the covers 121 and 122, respectively. Therefore, as illustrated in FIG. 2, in order to receive the suspension units 200, the cover 121 according to the present embodiment may include receiving spaces 130 each formed in a shape matched to the suspension unit 200. However, the receiving space of the present disclosure is not limited to that formed in the cover 121 as illustrated in FIG. 2. There may also be another embodiment in which the receiving space is formed not in the cover 121 but in the flywheel 111, and there may be still another embodiment in which the receiving space is formed in both the cover 121 and the flywheel 111.

The ground wheel 300 is in direct contact with the ground; therefore, as illustrated in FIGS. 1 and 2, opposite ends of the ground wheel 300 may be respectively assembled to one suspension unit formed on one surface of the flywheel unit and the other suspension unit formed on the other surface of the flywheel unit.

As illustrated in FIG. 2, the ground wheel 300 may include a body 310 and a tire 320.

As illustrated in FIG. 2, the body 310 may be rotatably assembled to the outer end of the suspension unit 200, i.e. an outer end of the rod 220. The body 310 may be formed of any of various materials, but may be formed of a material having a certain rigidity or more.

The tire 320 may be formed to surround outside of the body 310 and may be directly rubbed against the ground. In order to increase a grip force, the tire 320 may be formed of any one of various materials highly resistant to a rubbing force. For example, the tire 30 may be formed of material such as rubber, silicone and urethane.

As illustrated in FIG. 2, a plurality of protrusions may be formed on an outer surface of the tire 320 to increase the grip force of the tire 320.

Hereinafter, the above-described configurations of the present disclosure are described in more detail with reference to the accompanying drawings.

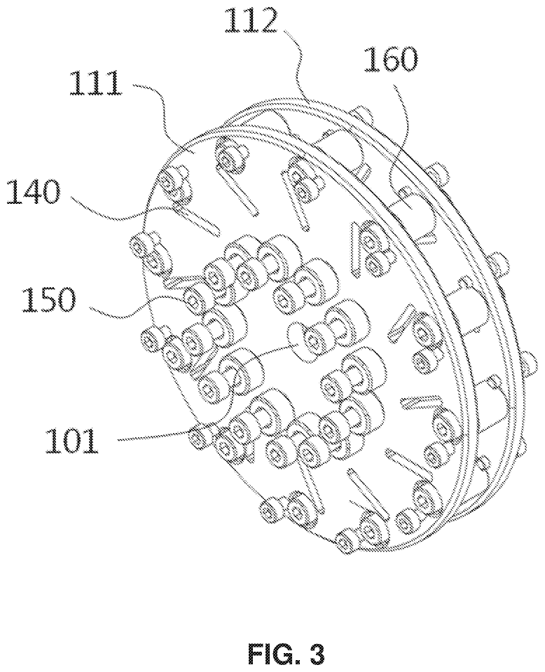

FIG. 3 illustrates only the first and second flywheels 111 and 112 described above.

As illustrated in FIG. 3, the first flywheels 111 and the second flywheels 112 may be spaced apart from and assembled to each other. The reason why the first flywheels 111 and the second flywheels 112 are spaced apart from and assembled to each other is to reduce a load of the flywheel unit; to keep the omni wheel from getting stained by foreign material and discharge the foreign material into a space between the first flywheels 111 and the second flywheels 112 when a vehicle or a moving body using the omni wheel according to the present disclosure is driven; and simultaneously, to improve maintainability of the first flywheels 111 and the second flywheels 112.

As illustrated in FIG. 3, a plurality of spacing bolts 160 may be assembled penetrating through the first flywheels 111 and the second flywheels 112 so that the first flywheels 111 and the second flywheels 112 may be spaced apart from and assembled to each other.

As illustrated in FIG. 3, a plurality of inserting spaces 140 may be formed in the flywheel 111. The inserting space 140 is for fixing the suspension unit and may be formed to be recessed or penetrated to some extent from an outer surface of the flywheel 111 to an inside of the flywheel unit.

The inserting space 140 is for increasing an assembly force of the suspension unit, which is not illustrated in FIG. 3. As illustrated in FIG. 3, the plurality of inserting spaces 140 may be formed radially around the rotation axis 101 in the same manner as the suspension unit. A configuration of the suspension unit inserted into the inserting space 140 is described below.

As illustrated in FIG. 3, on the outer surface of the flywheel 111, a plurality of fixing bolts 150 are arranged around the rotation axis 101. The fixing bolt 150 is for fixing an end of the cylinder body 210 of the suspension unit in the direction of the rotation axis. The number of the fixing bolts 150 may depend on the number of the suspension units assembled to a single flywheel 111.

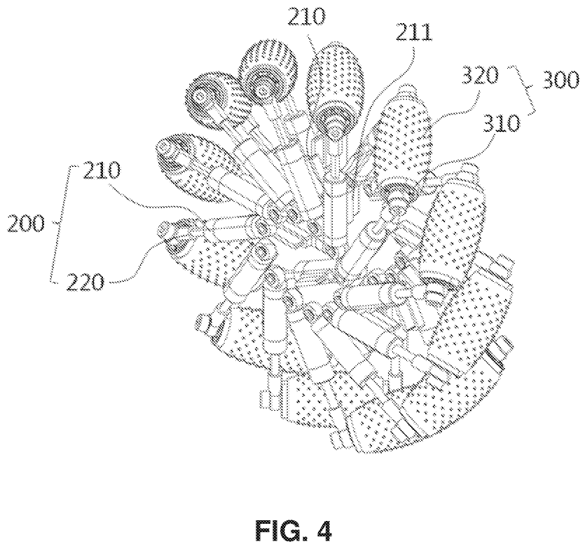

FIG. 4 illustrates an assembled state of the suspension unit 200 and the ground wheel 300.

As illustrated in FIG. 4, the cylinder body 210 of the suspension unit 200 may include an insertion protrusion 211 protruding into the flywheel unit.

The insertion protrusion 211 is inserted into the inserting space 140 of the flywheel 111 illustrated in FIG. 3. The insertion protrusion 211 may be formed in a shape that may be matched or inserted to the inserting space 140.

The reason why the insertion protrusion 211 is inserted into the inserting space 140 of the flywheel 111 is to increase an assembly force between the cylinder body 210 on which the insertion protrusion 211 is formed and the flywheel 111. That is, in the present embodiment, the suspension unit 200 and the flywheel 111 are primarily fixed to each other by inserting the insertion protrusion 211 of the suspension unit 200 into the inserting space 140; the suspension unit 200 and the flywheel unit are secondarily fixed to each other by assembling the cover 121 to the flywheel 111 with the suspension unit 200 interposed therebetween; and as a result, the assembly force therebetween is increased.

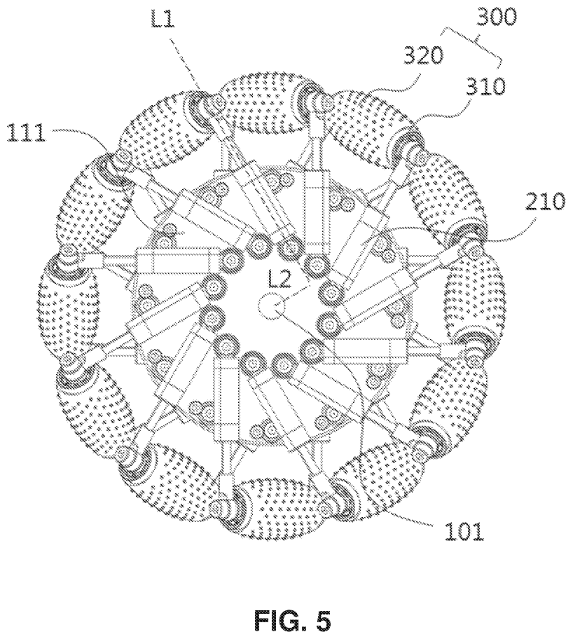

FIG. 5 is a front view illustrating an assembled state of the flywheel 111, the suspension unit 200 and the ground wheel 300, except for the cover 121, among the components illustrated in FIG. 2.

As illustrated in FIG. 5, the suspension units 200 are formed radially around the rotation axis 101; here, an imaginary line L1 in which the suspension unit 200 extends may be formed spaced apart by a predetermined distance L2 to be perpendicular to the rotation axis 101. In other words, a direction in which the suspension unit 200 extends (L1 direction) may be the same as a tangential direction of a circle with the imaginary line L2 as a radius thereof.

As illustrated in FIG. 5, the suspension units 200 assembled to the the first flywheels 111 and the second flywheels 112 may have extending directions different from each other. That is, referring to FIG. 5, when the suspension unit 200 assembled to the first flywheel 111 extends inclined toward a counterclockwise direction, the suspension unit 200 assembled to the second flywheel 112 may extend inclined toward a clockwise direction.

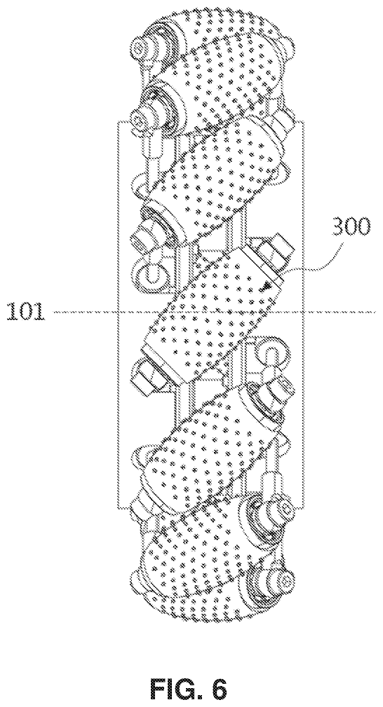

FIG. 6 illustrates a side view of the omni wheel 10 including a suspension structure according to the first exemplary embodiment of the present disclosure.

As illustrated in FIG. 6, when the omni wheel 10 including a suspension structure according to the first exemplary embodiment of the present disclosure is viewed in such a manner that the rotation axis 101 is in a horizontal direction (i.e. extending in horizontal left and right as indicated by a dotted line in FIG. 6), each of the ground wheels 300 may be assembled to the suspension units 200 formed on the first flywheel 111 and the second flywheel 112, respectively, in such a manner that the ground wheel 300 disposed closest to the rotation axis 101 forms a diagonal line staggered with the rotation axis 101.

As illustrated in FIG. 6, the ground wheel 300 may be assembled to the suspension units 200 to form the diagonal line with the rotation axis 101 not only in the horizontal direction but also in a vertical direction when viewing a side of the omni wheel.

As illustrated in the drawings, the reason why the ground wheel 300 is assembled in a diagonal direction is that a vehicle or a moving body, using a plurality of omni wheels 10 each including a suspension structure according to the present embodiment, may change a moving direction of the vehicle or the moving body in a left/right direction as well as a forward/backward direction by changing a rotational direction of each omni wheel. For example, a four-wheeled vehicle or a moving body using four omni wheels according to the present embodiment may move forward/backward by allowing the four omni wheels to have the same rotational direction; and may move left/right by allowing the front omni wheels of the four omni wheels and the rear omni wheels of the four omni wheels to have different rotational directions from each other.

### Second Exemplary Embodiment

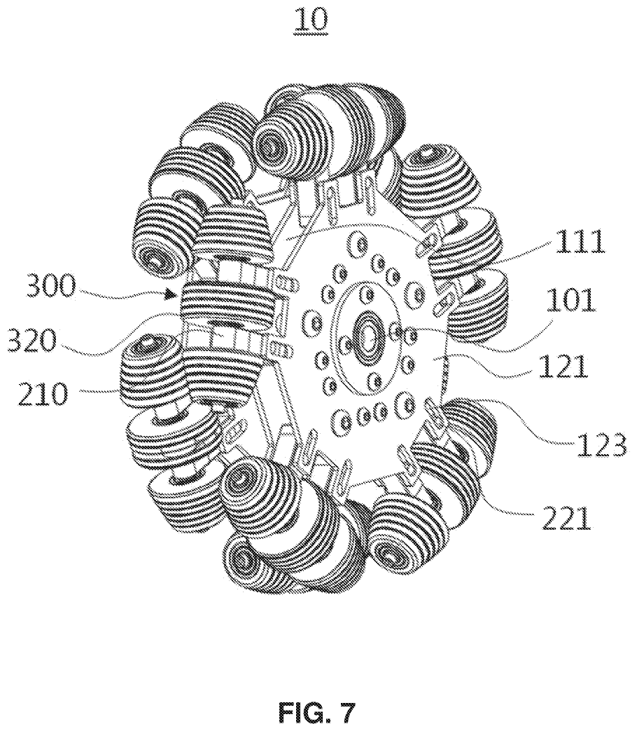

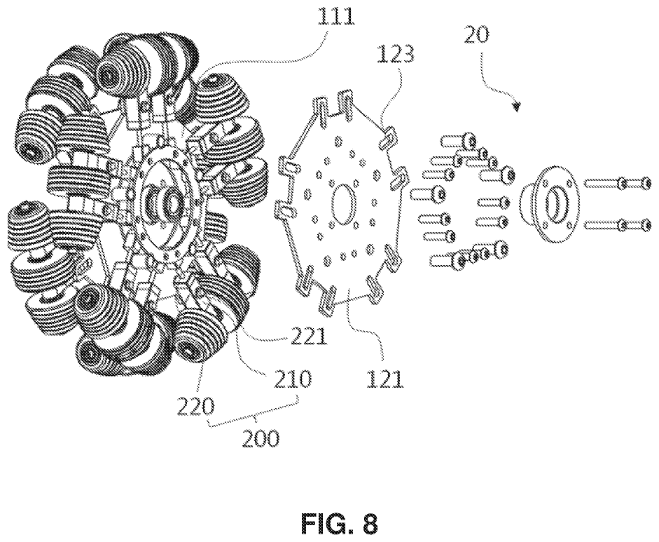

FIG. 7 illustrates an assembled state of an omni wheel including a suspension structure according to a second exemplary embodiment of the present disclosure, and FIG. 8 illustrates a partially-disassembled state of the omni wheel including a suspension structure according to the second exemplary embodiment of the present disclosure.

As illustrated in FIGS. 7 and 8, in the omni wheel including a suspension structure according to the second exemplary embodiment of the present disclosure, a first flywheel 111 and a first cover 121 may be spaced apart from and assembled to each other. In the present embodiment, the first flywheel 111 and the first cover 121 may be formed in the same shape, and suspension units may be formed radially around a rotation axis 101 between the first flywheel 111 and the first cover 121.

As illustrated in FIGS. 7 and 8, a guide hole 123 may be formed in a first cover 121, and a guide hole having the same shape as the guide hole 123 may also be formed in the same position of the first flywheel 111 as the guide hole 123 formed in the first cover 121.

As illustrated in FIGS. 7 and 8, one end of a cylinder body 210 included in the suspension unit may be assembled to a ground wheel 300 and the other end of the cylinder body 210 may be assembled to a rod 220. That is, in the present embodiment, as compared with the omni wheel including a suspension structure according to the first embodiment of the present disclosure described above, the positions to which the cylinder body 210 and the rod 220 are assembled may be reversed to each other. As illustrated in the present embodiment, when the rod 220 is positioned in a direction close to the rotation axis 101 and the cylinder 210 is positioned in a direction away from the rotation axis 101, the rod 220 is fixed, and the cylinder 210 may move depending on a movement of the omni wheel according to the present embodiment.

As illustrated in FIGS. 7 and 8, an insertion protrusion 211 may be formed on an outer surface of the cylindrical body 210 and inserted into the guide hole 123. An extended length of the guide hole 123 may be longer than that of the insertion protrusion 211. Also, the guide hole 123 and the insertion protrusion 211 in the present embodiment may restrict a movement radius of the cylinder body 210 which depends on a movement of the omni wheel according to the present embodiment and fix the suspension unit to the first flywheel 111 and the first cover 121. Although not referred to by separate reference numerals, a guide hole formed in the first flywheel 111 functions as the inserting space 140 in the omni wheel including a suspension structure according to the first embodiment of the present disclosure described above; and a guide hole formed in the first cover 121 functions as the receiving space 130 in the omni wheel including a suspension structure according to the first embodiment of the present disclosure described above.

As illustrated in FIG. 8, the first flywheel 111 may be assembled to the first cover 121 with the suspension unit 200 interposed therebetween and then fixed by a fixing member 20.

Referring to FIGS. 7 and 8, in the omni wheel including a suspension structure according to the second exemplary embodiment of the present disclosure, ends of the two suspension units 200 formed on one surface of the first flywheel 111 may be connected to middle ends of a single ground wheel 300. That is, although not illustrated in FIGS. 7 and 8, the ends of the two suspension units 200 may be assembled to the middle ends of a single body of the ground wheel 300, respectively, with a certain distance from each other. A tire 320 may be formed to surround a surface of a body of the ground wheel 300 except for portions to which the ends of the suspension units 200 are assembled. In particular, in the present embodiment illustrated in FIGS. 7 and 8, the body is divided into three parts by the suspension unit 200. Among the divided bodies, an outermost pair thereof may be formed in a trapezoidal cross-section as illustrated in FIGS. 7 and 8; and the tire may also be formed in a trapezoidal cross-section in agreement with the outermost pair of the divided bodies.

As described above, in the omni wheel including a suspension structure according to the present disclosure, due to the individual suspension structure used for each of the ground wheels in direct contact with the ground, there is an effect that the vehicle or the moving body using the omni wheel including a suspension structure according to the present disclosure may sustain an increased weight thereof and load a heavy load.

In addition, due to the individual suspension structure used for each of the ground wheels, there is an effect that the vehicle or the moving body using the omni wheel including a suspension structure according to the present disclosure may easily drive on a rough terrain such as a stairway or a bumpy ground.

Although the present disclosure is shown and described with respect to specific embodiments, it is apparent to those having ordinary skill in the art that the present disclosure may be variously modified and altered without departing from the spirit and scope of the present disclosure as defined by the following claims.

1. An omni wheel including a suspension structure, the omni wheel comprising:
a flywheel unit receiving power from outside and rotating around a rotation axis;
suspension units formed radially on opposite surfaces of the flywheel unit; and
a ground wheel connected to ends of at least two of the suspension units.

2. The omni wheel including a suspension structure of claim 1, wherein opposite ends of the ground wheel are connected to ends of a pair of the suspension units formed on one surface and the other surface of the flywheel unit, respectively.

3. The omni wheel including a suspension structure of claim 1, wherein the ground wheel is connected to ends of at least two of the suspension units formed on one surface of the flywheel unit.

4. The omni wheel including a suspension structure of claim 1, wherein the flywheel unit includes a pair of flywheels spaced apart from and assembled to each other.

5. The omni wheel including a suspension structure of claim 1, wherein the flywheel unit further includes covers covering outer surfaces of the flywheels, and
the suspension units are positioned between the flywheel and the cover.

6. The omni wheel including a suspension structure of claim 5, wherein an insertion protrusion is formed on one surface of the suspension unit, and
an inserting space to which the insertion protrusion is inserted is formed to be recessed in or to penetrate through one surface of the flywheel or the cover.

7. The omni wheel including a suspension structure of claim 1, wherein receiving spaces are formed radially on the opposite surfaces of the flywheel unit, and
each of the suspension units includes:
a cylinder body inserted to the receiving space;
a piston structure and a shock spring inserted to the cylinder body; and
a rod having an end to which the piston structure is connected.

8. The omni wheel including a suspension structure of claim 7, wherein a fluid fills the cylinder body.

9. The omni wheel including a suspension structure of claim 1, wherein the ground wheel includes a body rotatably assembled to the suspension unit at a distal end or middle ends of the ground wheel and
a tire surrounding the body.

10. The omni wheel including a suspension structure of claim 9, wherein protrusions are formed on a surface of the tire.

11. The omni wheel including a suspension structure of claim 1, wherein the suspension unit may extend in a direction may be a tangential direction of an imaginary circle having the rotation axis and having a radius smaller than a radius of the flywheel unit.

12. The omni wheel including a suspension structure of claim 2, wherein when viewing the rotation axis of the flywheel unit in a horizontal direction or in a vertical direction, the ground wheel is assembled to the suspension units so that a direction in which the ground wheel extends forms a diagonal line with the rotation axis.
